(19) United States
(12) Patent Application Publication
(10) Pub. No.: US 2021/0329370 A1
(43) Pub. Date: Oct. 21, 2021

(54) METHOD FOR PROVIDING SERVICE USING EARSET

(71) Applicant: Orfeo SoundWorks Corporation, Seoul (KR)

(72) Inventor: Eundong KIM, Uiwang-si (KR)

(73) Assignee: Orfeo SoundWorks Corporation, Seoul (KR)

(21) Appl. No.: 17/292,448

(22) PCT Filed: Nov. 13, 2019
(86) PCT No.: PCT/KR2019/015464

§ 371 Date: May 9, 2021

(30) Foreign Application Priority Data
Nov. 14, 2018 (KR) 10-2018-0139686
Apr. 4, 2019 (KR) 10-2019-0039340
Nov. 13, 2019 (KR) 10-2019-0145035

(51) Int. Cl. H04R 1/10; H04R 1/28; H04R 5/033; H04R 5/04; H04W 4/80

(52) U.S. Cl. CPC H04R 1/1083; H04R 1/1041; H04R 1/1016; H04R 2420/07; H04R 5/033; H04R 5/04; H04W 4/80; H04R 1/2807

(57) ABSTRACT

Disclosed are a system and a method for providing an application service using a noise-blocking earset. The system and method for providing an application service using a noise-blocking earset, according to the present invention, comprise: a wireless earset comprising a left earphone, which comprises a left speaker driver unit, a left microphone, and a left wireless communication module, and a right earphone, which comprises a right speaker driver unit, a right microphone, and a right wireless communication module; and a terminal which carries out processing and control of sound and voice signals for each of the left earphone and right earphone and provides a service corresponding to the execution of an application, wherein the wireless earset is a noise-blocking earset, and the noise-blocking earset is configured such that the back holes of the left speaker driver unit and the right speaker driver unit communicate with microholes that block out noise.

### TECHNICAL FIELD

The present invention relates to a service providing method using a noise blocking headset, and more particularly, to a system and method for providing an application service using a noise blocking earset that is capable of making use of the noise blocking earset whose voice recognition rate is improved through external noise blocking, thereby providing the application service such as interpretation, writing meeting minutes, messenger, and so on.

### BACKGROUND ART

With the development of wireless communication technologies, recently, various wireless communication services have been provided. In specific, as near field wireless communication technologies as well as mobile communication technologies are improved, it becomes possible that wireless equipment and terminals provide various wireless communication services including simple massage transmission and multimedia service supply.

So as to develop the near field wireless communication technologies by which surrounding equipment is connected to a big network through wireless communication, moreover, many studies have been actively made. The near field wireless communication technologies include wireless local area network (LAN), Bluetooth, infrared data association (IrDA), ZigBee, ultra-wideband (UWB), and so on. Among them, Bluetooth having a relatively small amount of power consumed is widely used, and technologies for large capacity transmission and minimization of power consumed have been consistently studied.

Recently, many earsets on which a Bluetooth module is mounted have been launched to the market. The earsets can perform various functions like sound outputs, calling, connected terminal control, and so on.

Further, a left earphone and a right earphone are wiredly or wirelessly connected to each other, and recently, a wireless earset having a left earphone and a right earphone wirelessly connected to each other has been launched to the market. The wireless earset is called True Wireless Stereo (TWS) earset.

Like this, in the case where the left earphone and the right earphone are wirelessly connected to each other, the respective earphones can be used independently of each other, thereby providing various services. In specific, the left earphone is worn on the ear of a first user, and the right earphone is worn on the ear of a second user. Accordingly, they listen to music, together, or they are served with various services like interpretation.

So as to allow various services like interpretation to be served, further, a microphone is built in the earset to receive an utterer's voice, but there are limitations in making use of the interpretation service in a place where external noise is seriously generated.

Accordingly, there is a need to improve the voice recognition rate in the earset having the microphone. In particular, there is a need to improve the vice recognition rate of the earset even in a place where external noise is seriously generated.

Now, a configuration of the earset and the problems caused by the configuration of the earset will be briefly explained.

An earset as a typical in-ear earphone is a sound device inserted into the auricle and the ear canal to listen to sounds.

As the earset is inserted into the ear canal, an atmospheric pressure difference between the inside of the earset (human body pressure) and the outside of the earset (atmospheric pressure) is caused. In specific, an ear tip of the earset comes into close contact with the inner peripheral wall of the ear canal, and accordingly, the atmospheric pressure difference between the inside of the earset and the outside of the earset is made. However, the atmospheric pressure difference has an influence on the vibration plate of a speaker driver unit. In specific, the vibration plate is inclined toward the outside of the earset. In this case, it is hard to output sounds, and further, the sounds are distorted.

So as to prevent the vibration plate from being inclined toward the outside of the earset, a back hole is formed on the rear surface of the speaker driver unit. The back hole communicates with the through hole formed on a case of the earset and thus serves to maintain the atmospheric pressures at the inside and outside of the earset to the same level as each other. Accordingly, the vibration plate can be vibrated at a regular position. In this case, the speaker driver unit is largely classified into a dynamic driver unit and a balanced armature driver unit.

Upon the operation of the vibration plate, on the other hand, artificial control may be performed so as to generate the atmospheric pressure difference, and to do this, the back hole may be covered with dampers having different mesh densities. Through the method, the speaker driver unit can be tuned.

However, the back hole formed on the rear surface of the speaker driver unit undesirably serves as a path through which external noise is introduced. So as to avoid the problem, if the back hole is blocked, the inclination of the vibration plate may occur, so that the earset cannot be used at the interior of an airplane or on a high mountain area. Further, if the back hole of the speaker driver unit is blocked, the vibration plate is suppressed from being vibrated to thus cause the sounds to be distorted.

Accordingly, there is a need for developing a new earset capable of preventing external noise from being introduced thereinto through the back hole formed on the rear surface of the speaker driver unit so that the qualities of speaker sounds and an utterer's voice can be improved.

### DISCLOSURE

### Technical Subject

Accordingly, the present invention has been made to solve the above-mentioned problems, and it is an object of the present invention to provide a system and method for providing an application service using a noise blocking earset that is capable of making use of the noise blocking earset whose voice recognition rate is improved through external noise blocking, thereby improving the accuracy in application service such as interpretation, writing meeting minutes, messenger, and so on.

### Technical Solution

To accomplish the above-mentioned objects, according to one aspect of the present invention, there is provided a system for providing an application service using a noise blocking earset, the system including: a wireless earset comprising a left earphone having a left speaker driver unit, a left microphone, and a left wireless communication module, and a right earphone having a right speaker driver unit, a right microphone, and a right wireless communication module; and a terminal for performing processing and control of sound and voice signals for each of the left earphone and the right earphone and for providing a service corresponding to the execution of an application, wherein the wireless earset is the noise blocking earset which is configured to allow back holes formed on the left speaker driver unit and the right speaker driver unit to communicate with microholes for blocking out noise.

According to the present invention, the terminal includes: a near field wireless communication module for performing wireless communication to each of the left earphone and the right earphone; and an earset controller for performing transmitting and receiving control for the wireless earset correspondingly to a user's setting or the voice signal. In this case, the real time conversion of the left earphone and the right earphone into a master or slave earset is controlled by means of the earset controller. On the other hand, the terminal is connected to other terminals through a mobile communication network or near field wireless communication network.

According to the present invention, the left microphone and the right microphone are in-ear microphones, each in-ear microphone being isolatedly built from the speaker driver unit on which the back hole is formed, the speaker driver unit and the in-ear microphone being built in a case with a through hole formed thereon in such a manner as to be isolated from the through hole by means of a separator having the microhole adapted to allow the through hole to communicate with the back hole, and between the microhole and the back hole is formed a resonance space. In this case, the separator having the microhole is a resonance case adapted to cover the rear surface of the speaker driver unit on which the back hole is formed. Further, the separator is an inner wall of the case or a printed circuit board (PCB).

According to the present invention, the application includes an interpretation program, a meeting minutes writing program, and a messenger program.

To accomplish the above-mentioned objects, according to another aspect of the present invention, there is provided a method for providing an application service using a noise blocking earset, the method including the steps of: performing noise blocking in a wireless earset in such a manner as to allow a back hole formed on a speaker driver unit constituting the wireless earset to communicate with a microhole for blocking out noise; producing a voice signal from which the noise is blocked out through an in-ear microphone of the wireless earset; and providing a service of an application through the processing and control of a terminal for the produced voice signal.

According to the present invention, in this case, the application is an interpretation program, and the voice signal produced from the wireless earset connected to the terminal is interpreted and transmitted to the counterpart wireless earset.

Further, the application is an interpretation program, and different languages are set to a left earphone and a right earphone of the wireless earset by means of the terminal.

In this case, a master right is applied to the earphone of an utterer, and the earphone of the counterpart who does not utter is converted to a slave.

On the other hand, the voice signal produced from the wireless earset is processed and transmitted to the counterpart terminal connected to a network by means of the terminal.

According to the present invention, in this case, the application is a meeting minutes writing program, and a voice signal produced from at least one or more wireless earsets connected to the terminal is converted into a text to thus write meeting minutes.

According to the present invention, in this case, the application is a messenger program, and a voice signal produced from at least one or more wireless earsets connected to the terminal is converted into a text and is transmitted in real time.

### Advantageous Effects

According to the present invention, the system and method for providing the application service using the noise blocking earset is capable of blocking external noise, thereby improving the qualities of speaker sounds and the utterer's voice and the accuracy in the application service such as interpretation, writing meeting minutes, messenger, and so on.

### BRIEF DESCRIPTION OF DRAWINGS

FIG. 1 is a block diagram showing a configuration of a system for providing an application service using a noise blocking earset according to an embodiment of the present invention.

FIG. 2 is a block diagram showing a configuration of a system for providing an application service using a noise blocking earset according to another embodiment of the present invention.

FIG. 3 is a concept view showing the noise blocking earset according to the embodiment of the present invention.

FIG. 4 is a concept view showing the noise blocking earset according to another embodiment of the present invention.

FIG. 5 is a concept view showing a noise blocking earset according to yet another embodiment of the present invention.

FIG. 6 is a concept view showing a noise blocking earset according to still another embodiment of the present invention.

FIG. 7 is a flowchart showing a method for providing an interpretation service as an example of the present invention.

FIG. 8 is a flowchart showing a method for providing a meeting minutes writing service as another example of the present invention.

FIG. 9 is a flowchart showing a method for providing a messenger service as yet another example of the present invention.

### BEST MODE FOR INVENTION

According to the present invention, a system for providing an application service using a noise blocking earset includes: a wireless earset comprising a left earphone having a left speaker driver unit, a left microphone, and a left wireless communication module, and a right earphone having a right speaker driver unit, a right microphone, and a right wireless communication module; and a terminal for performing processing and control of sound and voice signals for each of the left earphone and the right earphone and for providing a service corresponding to the execution of an application,

wherein the wireless earset is a noise blocking earset, and the noise blocking earset is configured to allow back holes formed on the left speaker driver unit and the right speaker driver unit to communicate with microholes for blocking out noise.

According to the present invention, moreover, a method for providing an application service using a noise blocking earset includes the steps of: performing noise blocking in a wireless earset in such a manner as to allow a back hole formed on a speaker driver unit constituting the wireless earset to communicate with a microhole for blocking out noise; producing a voice signal from which the noise is blocked out through an in-ear microphone of the wireless earset; and providing a service of an application through the processing and control of a terminal for the produced voice signal.

### MODE FOR INVENTION

Hereinafter, the present invention will now be described in detail with reference to the attached drawings wherein the corresponding parts in the embodiments of the present invention are indicated by corresponding reference numerals.

In the description, when it is said that one portion is described as “includes” any component, one element further may include other components unless no specific description is suggested.

The terms “means”, “unit”, “module”, or “block” in the specification and claims indicate a unit for processing at least one function or operation, which may be implemented by hardware, software, or a combination thereof.

Near field wireless communication technologies applicable in the present invention include wireless LAN, Bluetooth, IrDA, ZigBee, UWB, near field communication (NFC), and so on, but an embodiment wherein Bluetooth is used as the near field wireless communication technology will be described below. Of course, other examples as the near field wireless communication technologies may be applied to the present invention.

In explaining the operations of a noise blocking earset according to the present invention, further, the operations between the earset and a smartphone will be explained. In addition to the smartphone, of course, the earset according to the present invention may be connected to a terminal connectable through wireless communication and thus communicates to the terminal.

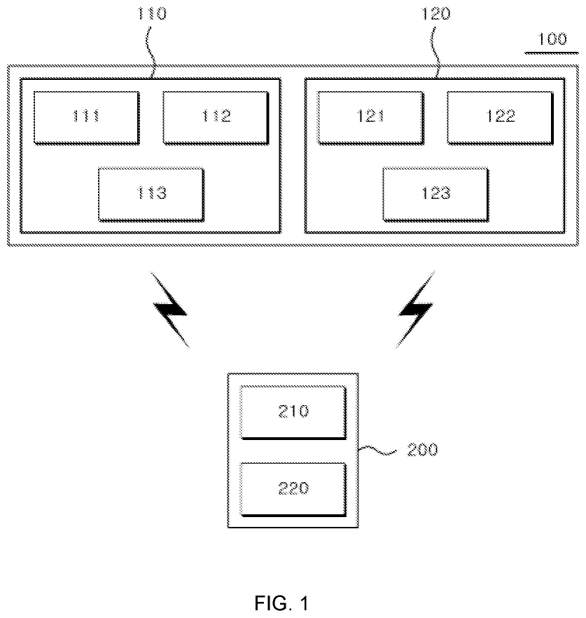

FIG. 1 is a block diagram showing a configuration of a system for providing an application service using a noise blocking earset according to an embodiment of the present invention.

Referring to FIG. 1, a system for providing an application service using a noise blocking earset according to an embodiment of the present invention includes: a wireless earset 100 comprising a left earphone 110 having a left speaker driver unit 111, a left microphone 112, and a left wireless communication module 113, and a right earphone 120 having a right speaker driver unit 121, a right microphone 122, and a right wireless communication module 123; and a smartphone 200 for performing processing and control of sound and voice signals for each of the left earphone 110 and the right earphone 120 and for providing a service corresponding to the execution of an application.

In this case, the smartphone 200 includes a near field wireless communication module 210 for performing wireless communication to each of the left earphone 110 and the right earphone 120 and an earset controller 220 for performing transmitting and receiving control for the wireless earset 100 correspondingly to a user's setting or the voice signal.

Under the above-mentioned configuration, the system for providing an application service using a noise blocking earset is configured to allow the left earphone 110 and the right earphone 120 to serve as a master or slave by means of setting (real time conversion) under the control of the earset controller 220. For example, as an icon displayed on the application of the smartphone 200 is clicked, the wireless earset 100 is in real time converted in serving as the master or slave. Otherwise, the wireless earset, which performs voice inputs through voice sensing, is automatically set as a master earset.

For example, if the system for providing an application service using a noise blocking earset according to the present invention is applied to an interpretation service, Korean is set to the left earphone 110, and English is set to the right earphone 120. In this state, if Korean voice is inputted, the left earphone 110 is set to the master earphone, and the right earphone 120 is set to the slave earphone. Accordingly, the smartphone 200 interprets the voice inputted to the left earphone 110 into English, transmits English to the right earphone 120, and plays English. Contrarily, if English voice is inputted, the right earphone 120 is set to the master earphone, and the left earphone 110 is set to the slave earphone. Accordingly, the smartphone 200 interprets the voice inputted to the right earphone 120 into Korean, transmits Korean to the left earphone 110, and plays Korean. In this case, the real time conversion into the master earset or slave earset is performed by means of the application of the smartphone 200 or the voice sensing. Otherwise, languages are determined according to the voice analysis of respective utterers, and accordingly, the master and slave earphones can be automatically set.

According to the present invention, on the other hand, one wireless earset 100 is connected to the smartphone 200, but of course, two or more wireless earsets 100 may be connected to one smartphone 200. Accordingly, the smartphone 200 may include a receiving module (not shown) through which the near field wireless communication module is connected to at least two or more wireless earsets 100 and may further include various near field communication modules.

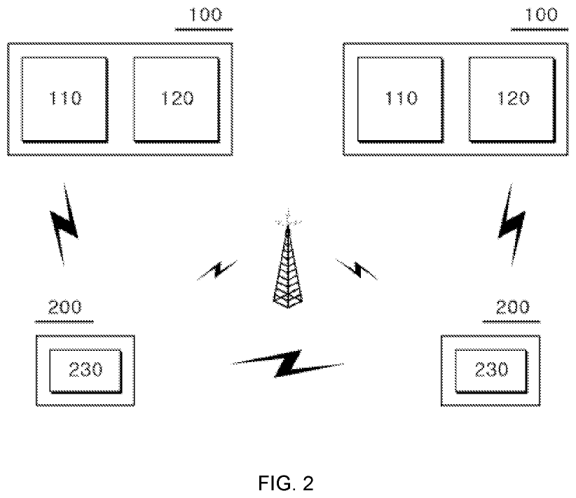

FIG. 2 is a block diagram showing a configuration of a system for providing an application service using a noise blocking earset according to another embodiment of the present invention.

Referring to FIG. 2, a system for providing an application service using a noise blocking earset according to another embodiment of the present invention is configured to allow at least one or more user terminals to be connected to a network which is a mobile communication network or near field wireless communication network.

In this case, each user terminal includes a wireless earset 100 and a smartphone 200 for performing processing and control of sound and voice signals for the wireless earset 100, providing a service corresponding to the execution of an application, and connected to the network.

As shown in FIG. 1, the wireless earset 100 includes a left earphone 110 having a left speaker driver unit 111, a left microphone 112, and a left wireless communication module 113, and a right earphone 120 having a right speaker driver unit 121, a right microphone 122, and a right wireless communication module 123.

The smartphone 200 includes either a mobile communication module 230 connected to the mobile communication network or the near field wireless communication module 210 for performing wireless communication to each of the left wireless communication module 113 and the right wireless communication module 123.

Further, as shown in FIG. 1, the smartphone 200 may include the earset controller 220 for performing transmitting and receiving control for the wireless earset 100 correspondingly to a user's setting or the voice signal.

Under the above-mentioned configuration, the system for providing an application service using a noise blocking earset is configured to allow the respective user terminals to be connected to the mobile communication network or the near field wireless communication network to perform services such as calling to the counterpart, writing meeting minutes, messenger, and so on. In this case, the processing for the voice signal is performed through the wireless earset 100, and the corresponding voice signal is processed in a state where external noise is blocked out, thereby improving the voice recognition rate and the qualities of speaker sounds.

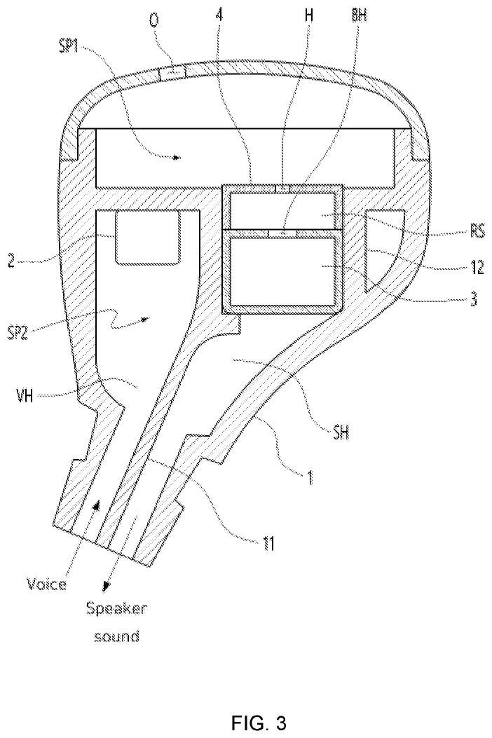

In the case where a meeting minutes writing service is served through the system of the present invention, for example, meeting minutes are written according to the uttered order of a plurality of meeting attendants through meeting minutes writing programs executed by the smartphones 200. Even in the case where a plurality of utterers talks simultaneously, only the voice of the corresponding utterer is processed through an in-ear microphone 2 as shown in FIGS. 3 to 5, thereby improving a voice recognition rate. Even in the case where the languages of the respective user terminals are different, on the other hand, the meeting minutes, which are interpreted through the interpretation service, can be written. Like the interpretation service, further, the meeting minutes writing service may be provided even in the case where different languages are used in the left earphone 110 and the right earphone 120 for one smartphone 200.

If the messenger service is provided through the system according to the present invention, further, the utterer's voice is converted into a text and is then transmitted to the counterpart, through messenger programs executed in the respective smartphones 200, thereby making it possible to transmit the text accurately through the improvement of the voice recognition rate, as mentioned above.

Like this, the services like the meeting minutes writing and the messenger may be provided through a noise blocking earset even if external noise exists. In specific, as shown in FIGS. 3 to 6 as will be discussed later, if external noise exists, the utterer's voice transferred through his or her mouth and the external noise are introduced through a through hole O of a case 1 into the earset, but the external noise is blocked out by means of a microhole H of a resonance case 4 or a through hole O and a mesh 5 of the resonance case 4, so that only the utterer's voice transferred to the ear canal through the Eustachian tube is introduced into the in-ear microphone 2 and is processed to the voice signal, thereby easily restoring to the utterer's original sounds in which the external noise is not included with ease. That is, the voice recognition rate is improved to transmit the utterer's voice accurately. Further, the external noise is blocked out through the microhole H of the resonance case 4 or the through hole O and the mesh 5 of the resonance case 4, thereby being in advance prevented from being introduced into a back hole BH of a speaker driver unit to improve the qualities of speaker sounds.

According to the present invention, on the other hand, the services like the meeting minutes writing and the messenger may be provided through one wireless earset 100 and one smartphone 200, but they may be provided by dividing the wireless earset 100 into the left earphone 110 and the right earphone 120 connected to one smartphone 200. That is, the left earphone 110 and the right earphone 120 serve as a master or slave by means of setting (real time conversion) under the control of the earset controller 220. For example, as an icon displayed on the application of the smartphone 200 is clicked, the wireless earset 100 is in real time converted in serving as the master or slave. Otherwise, the wireless earset, which performs voice inputs through voice sensing, is automatically set as a master earset.

In the case where the wireless communication to the smartphone 100 is carried out through the wireless earset 100, on the other hand, the accuracy of the voice recognition rate in the wireless earset 100 is important. Accordingly, there is a need to improve a recognition rate of the utterer's voice in a state where external noise exists, which requires a technology capable of removing the external noise from the earset. Hereinafter, configurations and functions of the wireless earset 100 according to embodiments of the present invention will be explained.

Before the explanation, first, kinds of holes as will be described below will be explained.

Firstly, a back hole BH represents a hole formed on the rear surface of a speaker driver unit.

Secondly, a microhole H represents a hole with a diameter of 100 μm or less, desirably, with a diameter of 40 μm or less.

Lastly, a through hole O represents a hole with a diameter of 100 μm or more.

Hereinafter, an explanation of a noise blocking earset according to embodiments of the present invention will be given.

Before the description, the embodiments of the present invention will be explained in the order as follows.

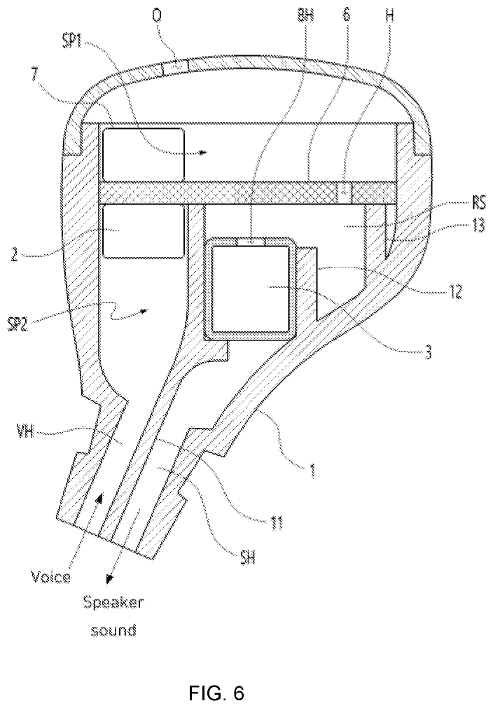

First, the embodiments in which a speaker driver unit and an in-ear microphone are built in the noise blocking earset according to the present invention will be explained (with reference to FIGS. 3 to 5). Next, the embodiment in which a speaker driver unit, an in-ear microphone, and an out-ear microphone are built in the noise blocking earset according to the present invention will be explained (with reference to FIG. 6).

However, the technology suggested in the present invention may be applied to an embodiment wherein the speaker driver unit and the out-ear microphone are built in the noise blocking earset according to the present invention and to an embodiment wherein only the speaker driver unit is built therein.

FIG. 3 is a concept view showing a noise blocking earset according to the embodiment of the present invention.

Referring to FIG. 3, the noise blocking earset according to the embodiment of the present invention includes a case 1 having a through hole O, an in-ear microphone 2 provided inside the case 1 to collect sounds received from the ear canal, and a speaker driver unit 3 provided inside the case 1 to output sounds to the ear canal.

In this case, further, a resonance case 4 is provided on the rear surface of the speaker driver unit 3, on which a back hole BH is formed.

Further, the resonance case 4 has a microhole H with a size capable of blocking external noise.

On the other hand, the microhole H may be formed at the position of the back hole BH of the speaker driver unit 3 by means of a laser, but in this case, a machining cost may be disadvantageously raised.

According to the present invention, as a result, the microhole H having a minimum diameter capable of blocking the external noise is formed on the resonance case 4. In specific, the microhole H has desirably a diameter of 100 μm or less, more desirably a diameter of 40 μm or less.

Also, the speaker driver unit 3 is selected from a dynamic driver unit and a balanced armature driver unit. If the dynamic driver unit as the speaker driver unit 3 is selected, the resonance case 4 is covered to a similar shape to the rear surface shape of the speaker driver unit 3 where the back hole BH is formed or to the same shape as the rear surface shape of the speaker driver unit 3. Generally, the resonance case 4 has a shape of a cylinder. On the other hand, if the balanced armature driver unit as the speaker driver unit 3 is selected, the resonance case 4 is covered to a similar shape to the rear surface shape of the speaker driver unit 3 where the back hole BH is formed or to the same shape as the rear surface shape of the speaker driver unit 3. Further, the contact surface between the rear surface of the speaker driver unit 3 and the resonance case 4 is sealed.

According to the present invention, the embodiment in which one in-ear microphone 2 and one speaker driver unit 3 are provided, but of course, two or more in-ear microphones 2 and two or more speaker driver units 3 may be provided.

According to the present invention, further, installation spaces SP1 and SP2 are separated through, for example, inner walls 11 and 12 and the resonance case 4, but they may be separated through the case, an inner wall separable from the case or coupled integrally with the case, or a printed circuit board (PCB). In specific, the installation spaces SP1 and SP2 can be separated through a separator having the case, the inner wall, or the PCB. If a resonance space RS is formed through the case, the inner wall, or the PCB, accordingly, the microhole H may be formed on the case, the inner wall, or the PCB.

If the inner wall as the separator is used, the resonance space RS is formed to a shape of a cylinder or polygon extended from the inner wall on which the microhole H is formed toward the speaker driver unit 3. In specific, in the case of the dynamic driver unit, the resonance space RS has a generally cylindrical shape, and in the case of the balanced armature driver unit, the resonance space RS has a shape of a generally rectangular post. As described above, of course, the resonance space RS desirably has a similar shape to the rear surface shape of the speaker driver unit 3 or has the same shape as that of the speaker driver unit 3. Further, the contact surface between the rear surface of the speaker driver unit 3 and the resonance case 4 is sealed.

If the PCB as the separator is used, further, the PCB is generally flat, and accordingly, the PCB is mounted to close a section cut at a given position of the case 1. When the given position of the case 1 is cut, in specific, the PCB perfectly closes the open region. Further, one surface of the PCB is located toward the installation space SP1, and the other surface is located toward the installation space SP2. In this case, the inner wall 11 through which the installation space SP2 is separated comes into contact with the PCB and is thus closed. Accordingly, the speaker driver unit 3 and the in-ear microphone 2 can be separatedly located around the inner wall 11.

The microhole H, which is formed in the noise blocking earset, through the various methods as mentioned above, serves to allow the back hole BH of the speaker driver unit 3 to communicate with the through hole O formed on the case 1.

In more specific, the technology in which the installation spaces SP1 and SP2 are separated from each other will be explained.

The interior of the case 1 is separated into the outer space SP1 and the inner space SP2 by means of the separator. According to the present invention, the inner walls 11 and 12 and the resonance case 4 constitute the separator. Of course, only the resonance case 4 can constitute the separator.

The inner space SP2 is separated through the first inner wall 11. Further, the in-ear microphone 2 is built in one side space separated through the first inner wall 11, and the speaker driver unit 3 is built in the other side space separated through the first inner wall 11.

The speaker driver unit 3 and the resonance case 4 are fitted to the space between the first inner wall 11 and the second inner wall 12 to spatially separate the outer space SP1 and a speaker sound path SH from each other. The in-ear microphone 2 is located on a microphone sound collecting path VH. That is, one side space where the in-ear microphone 2 is mounted forms the microphone sound collecting path VH, and the other side space where the speaker driver unit 3 is mounted forms the speaker sound path SH and the resonance space RS. Like this, one side space is used as the microphone sound collecting path VH. In this case, the microphone sound collecting path VH is formed on a nozzle portion of the space through the first inner wall 11 and the case 1, and the microphone sound collecting path VH is formed on a body center of the space through the first inner wall 11 and a separate voice guide inner wall (not shown). On the other hand, the other side space is used as the speaker sound path SH. In this case, the speaker sound path SH is formed on a nozzle portion of one side space through the first inner wall 11 and the case 1, and the speaker sound path SH or the resonance space RS is formed on a body center of one side space through the selection of the first inner wall 11, the second inner wall 12, and the case 1. Accordingly, the straightness of speaker playing sounds can be improved and low-frequency sounds can be gently played.

On the other hand, the diameter of the microhole H formed on the separator is desirably set according to the thickness of the separator. For example, a ratio of the diameter of the microhole H to the thickness of the separator is set to 1:100 to 1,000, desirably 1:1,000 or more. For example, if the thickness of the separator is 1 mm (1,000 μm), the diameter of the microhole H is set to the range of 1 to 10 μm.

Under the above-mentioned configuration, the noise blocking earset according to the present invention can block external noise by means of the microhole H formed on the separator such as the case, the inner wall, or the PCB, and can maintain atmospheric pressures at the inside and outside of the earset to the same level as each other. Further, the resonance space RS is formed between the microhole H and the rear surface of the speaker driver unit 3 on which the back hole BH is formed, thereby abundantly strengthening sounds.

In addition, the microhole H having a relatively small diameter is formed between the back hole BH and the through hole O, thereby serving as a low pass filter. When signal processed data through the microhole H is transmitted through a network, a high frequency range and a low frequency range are removed out of a bandwidth so as to reduce the quantity of data. In this case, the signal passing through the microhole H is in the low frequency range (below 100 Hz), and accordingly, the signal has no influence on the quantity of data.

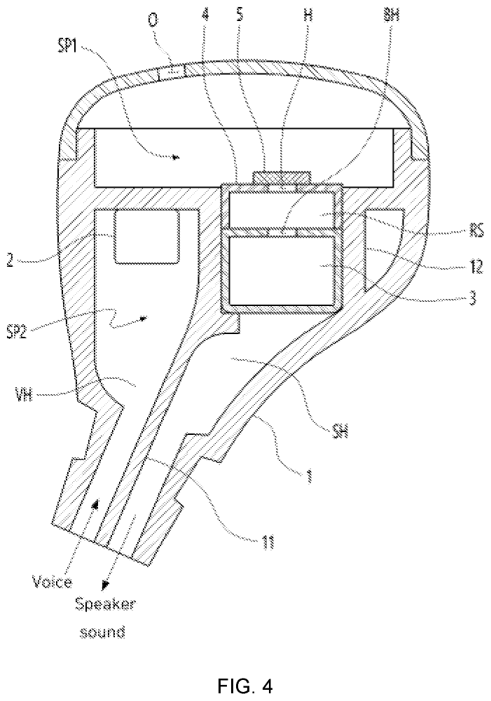

FIG. 4 is a concept view showing a noise blocking earset according to another embodiment of the present invention.

For the brevity of the description, on the other hand, an explanation of only the differences of the noise blocking earset of FIG. 4 from that of FIG. 3 will be given.

Referring to FIG. 4, the noise blocking earset according to another embodiment of the present invention is configured to have a through hole O formed on a resonance case 4 and to thus allow the through hole O to be covered with a mesh 5.

In specific, the through hole O with a larger diameter by 10 times than a hole with a minimum diameter (40 μm) capable of blocking external noise is formed, and next, the through hole O is covered with the mesh 5 having a density inversely proportional to the diameter of the through hole O. In this case, the density of the mesh 5 is determined in consideration of tuning, desirably in the range of ±20%. This is because the external noise is blocked out by means of the combination of the through hole O and the mesh 5. Through the interaction of the through hole O and the mesh 5, accordingly, the external noise can be blocked and the atmospheric pressures at the inside and outside of the earset can be maintained at the same level as each other.

If it is considered that the hole capable of blocking external noise has the diameter of about 40 μm, the through hole (microhole H) having a larger diameter (in the range of 0.4 to 0.6 mm) by 10 times than the hole is formed, and so as to add noise blocking capability to the through hole O that lacks the noise blocking capability as well as to provide sound tuning, the through hole O is covered with the mesh 5 having a high density of 300 to 600, so that the external noise can be prevented from being introduced into the ear canal and the in-ear microphone 2. That is, a desired technology for the in-ear microphone 2 can be embodied.

On the other hand, the embodiment wherein the through hole O is covered with the mesh 5 has been explained, but of course, the through hole O may be covered with a pad (not shown) on which a microhole is formed. Further, the mesh 5 may be covered on the microhole H of FIG. 1 for the purpose of tuning.

As shown in FIGS. 3 and 4, the noise blocking earset according to the present invention is configured to locate the resonance case 4 on the rear surface of the speaker driver unit 3 so as to block external block, thereby improving the qualities of sounds and preventing the external noise from being introduced into the in-ear microphone 2. That is, the earset according to the present invention can prevent the external noise introduced through the back hole BH formed on the rear surface of the speaker driver unit 3 from being transmitted to the utterer's ear canal or prevent the external noise from being inputted to the in-ear microphone 2 along the speaker sound path SH and the microphone sound collecting path VH. Further, the earset according to the present invention is configured to allow the resonance space RS to be formed on the rear surface of the speaker driver unit 3 in such a manner as to communicate with the through hole O of the case 1, thereby improving back volumes and maintaining the atmospheric pressures at the inside and outside of the earset to the same levels as each other. Accordingly, the low frequency sounds of the speaker driver unit 3 can be strengthened to thus improve the qualities of sounds.

In specific, the noise blocking earset according to the present invention is configured to allow the microhole H with the diameter of 100 μm, desirably about 40 μm that is capable of blocking external noise to be formed directly on the resonance case 4. Otherwise, the through hole O having the diameter of 100 μm or more is formed on the resonance case 4, and then, the through hole O is covered with the mesh 5 having the density inversely proportional to the diameter of the through hole O. Otherwise, the microhole H with the diameter of 100 μm, desirably about 40 μm that is capable of blocking external noise is formed on the resonance case 4, and for the purpose of tuning, next, the microhole H is covered with the mesh 5.

Through the resonance case 4 on which the microhole H is formed, accordingly, the atmospheric pressures at the inside and outside of the earset can be maintained to the same level as each other and the external noise introduced through the through hole O formed on the case 1 can be blocked.

Further, the resonance space RS is expanded by means of the resonance case 4, thereby increasing the back volumes, strengthening the low frequency sounds and improving the quality of sounds. Even if the sounds are reversely outputted through the back hole BH and the microhole H (the through hole O and the mesh 5, or the microhole H and the mesh 5) by means of the operation of the speaker driver unit 3, the sounds pass through the microhole H (the through hole O and the mesh 5, or the microhole H and the mesh 5) of the resonance case 4, so that only the low frequency sounds in the frequency of 100 Hz is outputted to thus block even the sounds leaking through the through hole O of the case 1.

On the other hand, the noise blocking earsets as suggested in FIGS. 3 and 6 each are configured to locate the resonance case 4 at the inside of the case 1, so that it requires a space for locating the resonance case 4 therein.

Accordingly, an explanation of a method for directly forming the microhole on the case, the inner wall, or the PCB that constitutes the separator will be given below.

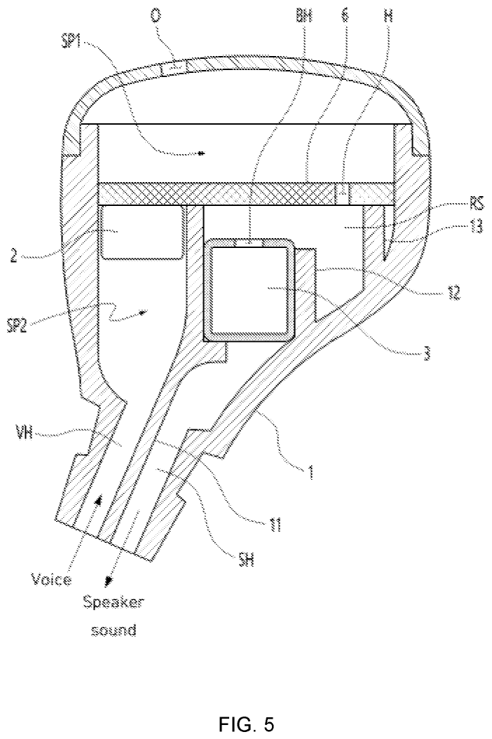

FIG. 5 is a concept view showing a noise blocking earset according to yet another embodiment of the present invention.

For the brevity of the description, on the other hand, an explanation of only the differences of the noise blocking earset of FIG. 5 from those of FIGS. 3 and 4 will be given.

Referring to FIG. 5, the noise blocking earset according to yet another embodiment of the present invention includes a case 1, a separator 6 for separating the space formed at the inside of the case 1 into an outer space SP1 and an inner space SP2 and having a microhole H formed thereon, a first inner wall for isolating the inner space SP2, an in-ear microphone 2 built in one side space separated through the first inner wall 1, a speaker driver unit 3 built in the other side space separated from the first inner wall 11, a second inner wall 12 for forming an installation space of the speaker driver unit 3, and a third inner wall 13 for forming a resonance space RS communicating with the rear surface of the speaker driver unit 3 on which a back hole BH is formed in such a manner as to be formed at a position allowing the resonance space RS to communicate with the microhole H.

The case, the inner wall, or a PCB may be used as the separator 6, and according to the present invention, the PCB is used as the separator 6. That is, the microhole H is formed on the PCB 6.

On the other hand, one side space is used as a microphone sound collecting path VH. In this case, the microphone sound collecting path VH is formed on a nozzle portion of one side space through the first inner wall 11 and the case 1, and the microphone sound collecting path VH is formed on a body center of one side space through the first inner wall 11 and a separate voice guide inner wall (not shown). On the other hand, the other side space is used as a speaker sound path SH. In this case, the speaker sound path SH is formed on a nozzle portion of the other side space through the first inner wall 11 and the case 1, and the speaker sound path SH or the resonance space RS is formed on a body center of the other side space through the selection of the first inner wall 11, the second inner wall 12, and the case 1. Accordingly, the straightness of speaker playing sounds can be improved and low-frequency sounds can be gently played. Further, the PCB 6 can be seated through the first inner wall 11 and the third inner wall 13.

On the other hand, a through hole O may be formed at a position of the microhole H. That is, if the through hole O having a diameter of 10 μm or more is formed at the position of the microhole H, the through hole O may be covered with a pad (not shown) on which a microhole is formed. Further, the embodiment in which the through hole O is covered with the pad has been explained, but the pad on which the microhole is formed may be directly mounted on the back hole BH of the speaker driver unit 3.

On the other hand, the pad is mounted on the outer space SP1 or the inner space SP2, and otherwise, the pad may be mounted directly on the PCB 6.

Various tuning may be possible according to the diameter size of the microhole formed on the pad. Further, if the pad is made in the form of a mesh, the tuning may be different according to the density of the mesh.

On the other hand, the speaker driver unit 3 is located on a speaker sound path SH, and in specific, the speaker driver unit 3 is located at the nozzle of the speaker sound path SH. Accordingly, the speaker sound path SH is short in front of the speaker driver unit 3, and the relatively large resonance space RS is formed behind the speaker driver unit 3.

FIG. 6 is a concept view showing a noise blocking earset according to still another embodiment of the present invention.

For the brevity of the description, on the other hand, an explanation of only the differences of the noise blocking earset of FIG. 6 from those of FIGS. 3 to 5 will be given.

Referring to FIG. 6, the noise blocking earset according to still another embodiment of the present invention further includes an out-ear microphone 7 located inside the case 1 to collect the sounds (voice and external noise) received from the outside thereof.

The out-ear microphone 7 is built in the outer space SP1. Further, the case 1 has a through hole O adapted to maintain an atmospheric pressure and to collect sounds.

According to the present invention, that is, the noise blocking earset is configured to have the case 1 with the through hole O formed thereon to allow the voice and external noise introduced through the through hole O to be inputted to the out-ear microphone 7, so that the out-ear microphone 7 checks whether an utterer's voice is produced or makes use of the voice inputted to the in-ear microphone 2 with reference to the utterer's voice inputted thereto as a reference signal for restoring to the utterer's original voice thereof. On the other hand, if the external noise with which the utterer's voice is mixed is greater than a set value, for example, 40 db, driving of the out-ear microphone 7 is stopped, and only the in-ear microphone 2 is driven, thereby desirably restoring to the utterer's original voice.

According to the noise blocking earsets as suggested in FIGS. 3 to 6, further, the embodiments in which the microhole H or the through hole O and the mesh 5 is (are) formed on the resonance case 4 have been explained, but of course, the microhole H and the mesh 5 may be formed on the resonance case 4. So as to achieve double noise blocking and tuning of the speaker driver unit 3, that is, the microhole H and the mesh 5 may be formed on the resonance case 4. As the resonance space RS is formed, accordingly, the vibration plate of the speaker driver unit 3 can be prevented from being inclined toward the outside of the earset. Therefore, the through hole O formed on the case 1 may be replaced with the microhole H. Accordingly, primary noise blocking is obtained through the microhole H formed on the case 1, and secondary noise blocking is obtained through the selection of the microhole H formed on the resonance case 4, the combination of the through hole O and the mesh 5, or the selective combination of the microhole H and the mesh 5.

Hereinafter, an explanation of an operation process of the system for providing an application service using the noise blocking earset according to the present invention will be given.

First, it is assumed that the system according to the present invention is connected to a mobile communication network according to the driving of the smartphone 200 and the noise blocking earset 100 is paired to the smartphone 200, and so as to perform the pairing, wire/wireless communication, desirably near field communication (NFC) such as Wi-Fi, Bluetooth, and so on is used. According to the present invention, an explanation of the operating process of the system using the noise blocking earset paired to the smartphone through Bluetooth will be given.

According to the present invention, on the other hand, transmitting and receiving processes between the noise blocking earset 100 and the smartphone 200 in the state where the noise blocking earset is paired to the smartphone 200 will be described, but the functions of the smartphone 200 may be provided in the noise blocking earset itself, so that the noise blocking earset itself can perform all of the transmitting and receiving processes.

According to the present invention, in addition, an embodiment in which the noise blocking earset (Bluetooth earset for calling) is configured to have the in-ear microphone 2 and the speaker driver unit 3 built therein and to have the resonance case 4 applied to the speaker driver unit 3.

According to the present invention, the noise blocking earset is in a standby state after an application is executed in response to a user's desired service request. In this case, it is checked whether utterance exists, and if the utterance exists, the processing and control for the utterance are performed in the application. That is, the voice is converted into a text to allow the corresponding function of the application thereto to be executed.

In this case, even if external noise exists around the wireless earset 100, the utterer's voice transferred through his or her mouth and the external noise are introduced through the through hole O of the case 1 into the noise blocking earset, but the external noise is blocked out by means of the microhole H of the resonance case 4 or the through hole O and the mesh 5 of the resonance case 4, so that only the utterer's voice transferred to the ear canal through the Eustachian tube is introduced into the in-ear microphone 2 and is processed to the voice signal, thereby blocking the counterpart's voice to allow the utterer's original sounds to be easily restored. That is, the voice recognition rate is improved to achieve accurate interpretation.

Hereinafter, a method for providing an application service using a noise blocking earset according to the present invention will be explained with reference to specific embodiments.

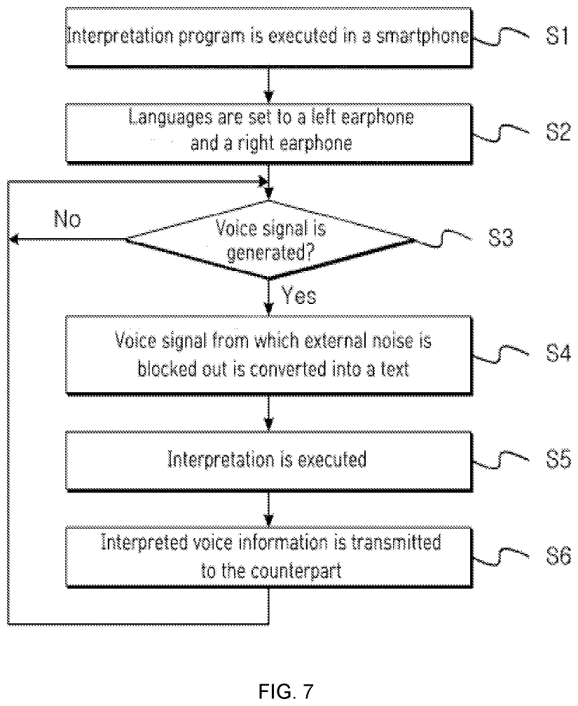

FIG. 7 is a flowchart showing a method for providing an interpretation service as an example of the present invention.

According to the present invention, on the other hand, an embodiment in which one wireless earset 100 is paired to one smartphone 200 and a left earphone 110 and a right earphone 120 are used by different language users will be described. Of course, as shown in FIG. 1, a plurality of wireless earset 100 may be connected to the smartphone 200 to provide a simultaneous interpretation service.

Referring to FIG. 7, an interpretation program is first executed in the smartphone 200 (at step S1), and languages are set to the left earphone 110 and the right earphone 120 (at step S2).

If a voice signal is generated from the left earphone 110 or the right earphone 120 (at step S3), the voice signal is converted into a text (at step S4). Next, the interpretation for the text is executed (at step S5), and the interpreted voice information is produced and transmitted to the counterpart (at step S6).

The above-mentioned steps are kept until the utterance does not exist for a set time or the pairing is finished.

In this case, the left earphone 110 and the right earphone 120 are connected to the smartphone 200 through near field wireless communication, and accordingly, even if the counterpart is close to the utterer, only the utterer's voice is introduced into the in-ear microphone 2 and is processed to the voice signal, thereby blocking the counterpart's voice to allow the utterer's original sounds to be easily restored.

On the other hand, the master earset and the slave earset can be set according to language setting. For example, if Korean is interpreted into English, the left earphone 110 is set to the master earset, and the right earphone 120 is set to the slave earset. However, the earset to which voice input is made through voice sensing may be set to the master earset. Otherwise, languages may be determined through the voice analysis of the respective counterparts, and the master or slave earset may be automatically set. Further, the conversion to the master or slave earset may be performed by means of packet copies.

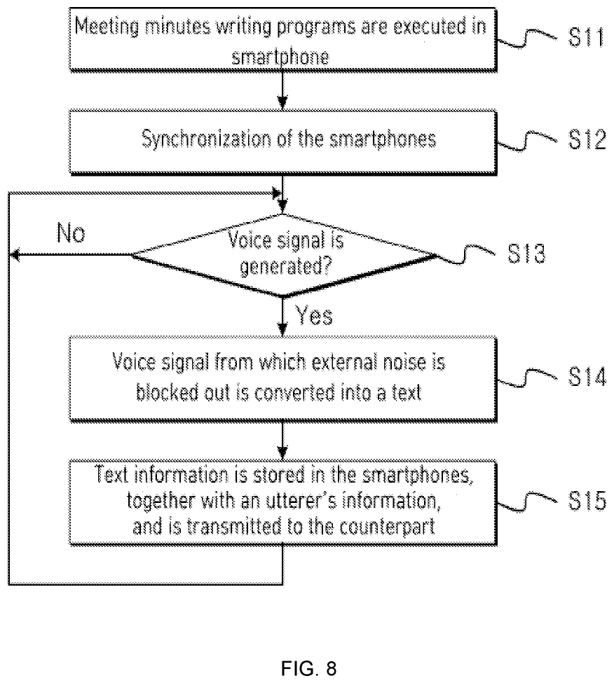

FIG. 8 is a flowchart showing a method for providing a meeting minutes writing service as another example of the present invention.

According to the present invention, on the other hand, an embodiment in which one wireless earset 100 is paired to one smartphone 200 and connection among the smartphones 200 is performed through a near field wireless communication network will be described. Of smartphones 200 is performed through a mobile communication network, and in a state where the left earphone 110 and the right earphone 120 operate independently of each other, meeting minutes may be written. Further, a plurality of wireless earset 100 may be connected to one smartphone 200 to provide the meeting minutes writing service.

Referring to FIG. 8, meeting minutes writing programs are first executed in the respective smartphones 200 (at step S11), and synchronization of the respective smartphones 200 is performed (at step S12).

If a voice signal is generated from the wireless earset 100 (at step S13), the voice signal is converted into a text (at step S14). Next, the text information is stored in the smartphones 200, together with an utterer's information, and simultaneously, the text information is transmitted to the counterpart smartphones 200 (at step S15).

The above-mentioned steps are kept until the meeting minutes writing programs are finished or the pairing of the wireless earset 100 is finished, and the meeting minutes are written in the order of the voice signals produced.

In this case, the connection among the smartphones 200 is performed through the near field wireless communication network, and accordingly, even if the meeting attendants are close to one another in the same space, only the utterer's voice is introduced into the in-ear microphone 2 and is processed to the voice signal, thereby blocking the voices of the counterparts to allow the utterer's original sounds to be easily restored.

On the other hand, in the same manner as the embodiment as shown in FIG. 7, a master right is desirably applied to the utterer so that the meeting minutes can be written sequentially. Further, the meeting minutes writing service can be interlinked with the interpretation service.

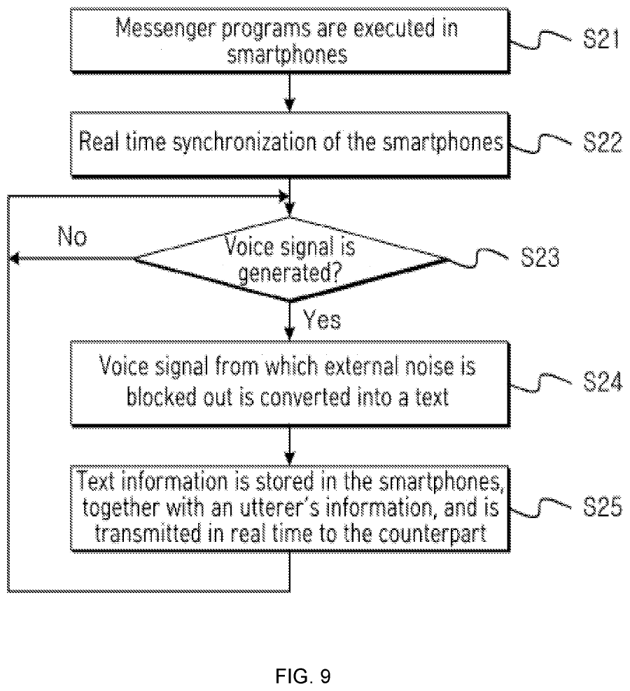

FIG. 9 is a flowchart showing a method for providing a messenger service as yet another example of the present invention.

According to the present invention, on the other hand, an embodiment in which one wireless earset 100 is paired to one smartphone 200 and connection among the smartphones 200 is performed through a mobile communication network will be described. Of course, as shown in FIG. 2, connection among the smartphones 200 is performed through a near field wireless communication network, and in a state where the left earphone 110 and the right earphone 120 operate independently of each other, the messenger service may be provided.

Referring to FIG. 9, messenger programs are first executed in the respective smartphones 200 (at step S21), and synchronization of the respective smartphones 200 is performed (at step S22).

If a voice signal is generated from the wireless earset 100 (at step S23), the voice signal is converted into a text (at step S24). Next, the text information is stored in the smartphones 200, together with an utterer's information, and simultaneously, the text information is transmitted to the counterpart smartphones 200 (at step S25).

The above-mentioned steps are kept until the messenger programs are finished or the pairing of the wireless earset 100 is finished, and the messages are made in the order of the voice signals produced and transmitted in real time to the counterparts.

In this case, even if external noise is generated around the utterer, only the utterer's voice is introduced into the in-ear microphone 2 and is processed to the voice signal, thereby blocking the voices of the counterparts to allow the utterer's original sounds to be easily restored. Further, the messenger service according to the present invention is usefully used to a person having visual impairment, and if the person having visual impairment makes use of the messenger service, a function through which the transmitted message is outputted to a voice is additionally provided. Further, the messenger service according to the present invention may be usefully used for the messenger service between a person having hearing impairment and a normal person. That is, the person having hearing impairment makes a message with characters, and next, the message is transmitted to the normal person through a voice. In other words, message input methods are differently set to provide the messenger service to them. This may be also applied to the interpretation service and the meeting minutes writing service.

On the other hand, in the same manner as the embodiment as shown in FIG. 7, a master right is desirably applied to the utterer so that the messages can be made and transmitted sequentially. Further, the messenger service can be interlinked with the interpretation service.

As described above, the technical scope of the present invention has been described with reference to the particular illustrative embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

### INDUSTRIAL APPLICABILITY

The present invention can be usefully used in a place where noise is seriously generated.

1. A system for providing an application service using a noise blocking earset, the system comprising:
a wireless earset comprising a left earphone having a left speaker driver unit, a left microphone, and a left wireless communication module, and a right earphone having a right speaker driver unit, a right microphone, and a right wireless communication module; and
a terminal for performing processing and control of sound and voice signals for each of the left earphone and the right earphone and for providing a service corresponding to the execution of an application,
wherein the wireless earset is the noise blocking earset which is configured to allow back holes formed on the left speaker driver unit and the right speaker driver unit to communicate with microholes for blocking out noise.

2. The system according to claim 1, wherein the terminal comprises:
a near field wireless communication module for performing wireless communication to each of the left earphone and the right earphone; and
an earset controller for performing transmitting and receiving control for the wireless earset correspondingly to a user's setting or the voice signal.

3. The system according to claim 2, wherein the real time conversion of the left earphone and the right earphone into a master or slave earset is controlled by means of the earset controller.

4. The system according to claim 1, wherein the terminal is connected to other terminals through a mobile communication network or near field wireless communication network.

5. The system according to claim 1, wherein the left microphone and the right microphone are in-ear microphones, each in-ear microphone being isolatedly built from the speaker driver unit on which the back hole is formed, the speaker driver unit and the in-ear microphone being built in a case with a through hole formed thereon in such a manner as to be isolated from the through hole by means of a separator having the microhole adapted to allow the through hole to communicate with the back hole, and between the microhole and the back hole is formed a resonance space.

6. The system according to claim 5, wherein the separator having the microhole is a resonance case adapted to cover the rear surface of the speaker driver unit on which the back hole is formed.

7. The system according to claim 5, wherein the separator is an inner wall of the case.

8. The system according to claim 5, wherein the separator is a printed circuit board (PCB).

9. The system according to claim 1, wherein the application comprises an interpretation program, a meeting minutes writing program, and a messenger program.

10. A method for providing an application service using a noise blocking earset, the method comprising the steps of:
performing noise blocking in a wireless earset in such a manner as to allow a back hole formed on a speaker driver unit constituting the wireless earset to communicate with a microhole for blocking out noise;
producing a voice signal from which the noise is blocked out through an in-ear microphone of the wireless earset; and
providing a service of an application through the processing and control of a terminal for the produced voice signal.

11. The method according to claim 10, wherein the application is an interpretation program, and the voice signal produced from the wireless earset connected to the terminal is interpreted and transmitted to the counterpart wireless earset.

12. The method according to claim 11, wherein different languages are set to a left earphone and a right earphone of the wireless earset by means of the terminal.

13. The method according to claim 12, wherein a master right is applied to the earphone of an utterer, and the earphone of the counterpart who does not utter is converted to a slave.

14. The method according to claim 10, wherein the voice signal produced from the wireless earset is processed and transmitted to the counterpart terminal connected to a network by means of the terminal.

15. The method according to claim 14, wherein the application is a meeting minutes writing program, and a voice signal produced from at least one or more wireless earsets connected to the terminal is converted into a text to thus write meeting minutes.

16. The method according to claim 14, wherein the application is a messenger program, and a voice signal produced from at least one or more wireless earsets connected to the terminal is converted into a text and is transmitted in real time.
